(19) United States
(12) Patent Application Publication
(10) Pub. No.: US 2010/0166102 A1
(43) Pub. Date: Jul. 1, 2010

(54) WINDOWED ORTHOGONAL DIVISION MULTIPLEXING FOR SPECTRUM AGILE RADIOS

(76) Inventor: Seyed-Alireza Seyedi-Esfahani, Fairport, NY (US)

Correspondence Address: PHILIPS INTELLECTUAL PROPERTY & STANDARDS, P.O. BOX 3001, BRIARCLIFF MANOR, NY, 10510, US

(21) Appl. No.: 12/095,628

(22) PCT Filed: Nov. 30, 2006
(86) PCT No.: PCT/IB2006/054534

§ 371 Date: May 30, 2008

Related U.S. Application Data
(60) Provisional application No. 60/741,287, filed on Nov. 30, 2005.

(51) Int. Cl. H04L 27/00

(52) U.S. Cl. 375/295

(57) ABSTRACT

A method of transmitting data includes modulating data onto a plurality of frequency carriers to produce a plurality of mutually orthogonal modulated frequency signals. The mutually orthogonal modulated frequency signals are then combined into an orthogonal frequency division multiplex signal, which in turn is windowed by a transmission windowing function to produce a windowed orthogonal frequency division multiplex signal. The windowed orthogonal frequency division multiplex signal is transmitted. The windowed orthogonal frequency division multiplex signal includes a first set of the frequency carriers uniformly spaced apart from each other in frequency by a spacing Δf, and a second set of the frequency carriers from each other in frequency by the same spacing Δf, and there is a notch of at least 2Δf between the first set of frequency carriers and the second set of frequency carriers.

This invention pertains to the field of digital communications, and more particularly, to a system and method of shaping the power spectral profile of an orthogonal frequency division multiplex (OFDM) transmission for use in spectrum agile radios.

With increasing demand and deployment of wireless communication systems, available bandwidth has become increasingly scarce. On the other hand, many studies show that currently allocated bands are underutilized to a great extent. It is envisioned that future communication systems will sense whether a frequency band is used at a particular point in time, and use the channel if it is idle. These systems must have the ability to detect the “incumbent” communication systems and avoid transmitting their signal in a specific band when that band is being used by an incumbent. These intelligent future communication systems are known as Spectrum Agile Radios (SAR) or Cognitive Radios (CR).

One current example is the use of SARs in the TV bands. On 25 May 2004, the United States Federal Communication Commission (FCC) issued a Notice of Proposed Rulemaking (NPRM) (FCC 04-113) in ET Docket No. 04-186 to allow unlicensed radio transmitters to operate within the broadcast television spectrum at locations where one or more of the allocated terrestrial television channels are not being used. However, the FCC stressed that such unlicensed transmitters would only be permitted with safeguards that insure no interference with the reception of licensed terrestrial television signals. Therefore, to prevent interference with terrestrial television service, it is important to insure that any such unlicensed transmitters do not operate on any frequencies or channels where a terrestrial television signal could otherwise be received and viewed in the same area.

Accordingly, in order to ensure that no interference is caused to TV stations and their viewers, the Commission proposed to require that these unlicensed transmitters incorporate the capability to identify unused or vacant TV channels and to only transmit on such vacant channels. One idea advanced by the FCC would be to incorporate sensing capabilities in the unlicensed transmitter to detect whether other transmitters (i.e., licensed terrestrial TV broadcast transmitters) are operating on a particular channel in the area before the unlicensed transmitter could be activated.

One attractive option for design of spectrum agile radios is to use a wideband OFDM system overlaying the frequency spectrum of multiple bands. An OFDM transmission consists of a plurality of comparatively low data rate modulated frequency carriers that are combined in the transmitter to form a composite high data rate transmission. Each frequency carrier in the OFDM system is a sinusoid with a frequency that is an integer multiple of a base or fundamental sinusoid frequency. Therefore, each carrier is like a Fourier series component of the composite signal. One key to the uniqueness and desirability of OFDM is the relationship between the carrier frequencies and the symbol rate. Each carrier frequency is separated by a multiple of 1/T (Hz), where the symbol rate (R) for each carrier is 1/T (symbols/sec). The effect of the symbol rate on each OFDM carrier is to add a sin(x)/x shape to each carrier's spectrum. The nulls of the sin(x)/x (for each carrier) are at integer multiples of 1/T. The peak (for each carrier) is at the carrier frequency k/T. Therefore, each carrier frequency is located at the nulls for all of the other carriers. This means that none of the carriers will interfere with each other during transmission, although their spectrums overlap. The ability to space frequency carriers so closely together is very bandwidth efficient and one of the desirable characteristics of an OFDM system.

One important advantage of such an OFDM system is the ability to transmit the signal over available, non-contiguous portions of a frequency band. Another advantage of such a system is that channel sensing on all channels can be performed in parallel and with little additional computational complexity. Accordingly, in such a system, when the system senses that one or more portions of the frequency band spanned by its OFDM frequency carriers are occupied by one or more primary (incumbent) transmissions (e.g., television signals) that must be protected, the system may turn off the OFDM frequency carriers that overlap with the incumbent-occupied portion(s) of the band to create one or more notches in the OFDM frequency spectrum, hence avoiding interference to the primary system(s).

However, one disadvantage of such a system is that when some frequency carriers are turned off, the amount of power transmitted in the portions of the band that are to be protected is not equal to zero. The power that is transmitted in the turned-off (notched) region is due to the side-lobes in the spectrum of the all other frequency carriers that are not turned-off.

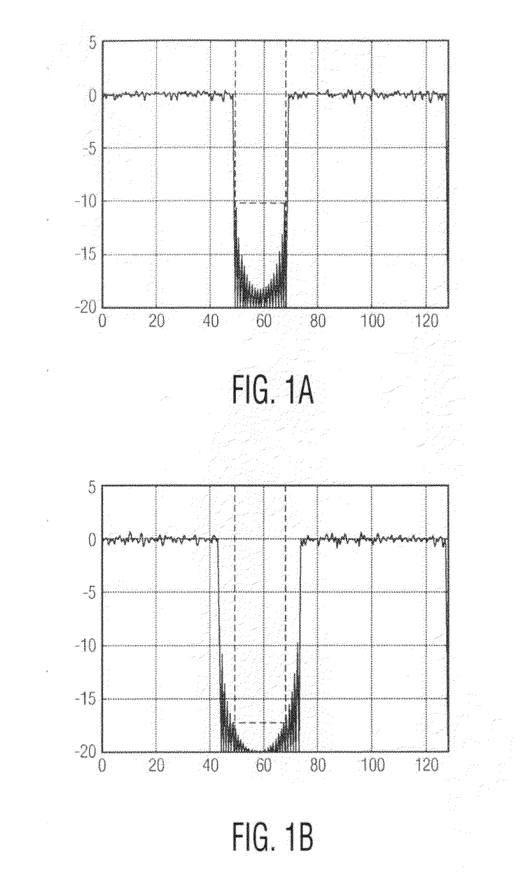

For example, FIG. 1A shows the frequency spectrum of an OFDM signal wherein a portion of the frequency band spanning X=20 of the OFDM frequency carriers is to be evacuated. As can be seen, when only the 20 frequency carriers in the portion of the frequency band to be evacuated are turned off, a notch of only 10.2 dB in depth results. By turning off 10 additional frequency carriers (five frequency carriers on each side), the depth of the notch across the width of the central 20 frequency carriers is increased to 17.2 dB (see FIG. 1B). While the amount of transmitted power in the portion of the band to be vacated is fairly reduced by turning off additional adjacent frequency carriers, the remaining power can still cause harmful interference to the primary (incumbent) systems that are in the vicinity of the transmitter. Furthermore, as more and more additional frequency carriers are turned off, the data capacity and/or the error correction robustness of the overall OFDM transmission is degraded.

One possible solution known as Active Interference Cancellation (AIC) uses additional adjacent frequency carriers to further suppress the power in the band to be vacated. In other words, if a notch of width X frequency carriers is desired, this method empties X frequency carriers, but also calculates the appropriate values to place on two (or more) adjacent frequency carriers such that the transmitted power in the band to be vacated (notched) is minimized. While this method increases the depth of the notch, it involves considerable computational complexity. The computational complexity is further increased in particular when multiple notches are desired, or when the location and width of the notch is time variable. Also, this method only performs well for narrow notches.

Accordingly, it would be desirable to provide a method of transmitting an OFDM signal that can create multiple deep, wide, notches in the transmission frequency band without excessive computational complexity. It also would be desirable to provide a transmitter adapted to transmit such an OFDM signal.

In one aspect of the invention, a method of transmitting data comprises providing P frequency carriers uniformly spaced apart across a frequency band; determining that an incumbent transmission is present in a portion of the frequency band spanning X of the P frequency carriers; turning off M of the frequency carriers spanning the portion of the frequency band where the incumbent transmission is present, where M≧X, and modulating data onto a remaining N≦P−M frequency carriers to produce N mutually orthogonal modulated frequency carriers; performing an inverse fast Fourier transform on the N mutually orthogonal modulated frequency carriers to produce N OFDM transmission symbols; Windowing the N OFDM transmission symbols with a window function WTX(n) and performing a parallel-to-serial conversion of the N OFDM transmission symbols to produce a windowed orthogonal frequency division multiplex signal; and transmitting a windowed orthogonal frequency division multiplex signal, wherein the M turned-off frequency carriers are consecutively arranged within the frequency band so as to create a notch in the frequency spectrum of the windowed orthogonal frequency division multiplex signal. Multiple groups of consecutively arranged frequency carriers may be left unmodulated and turned off to create multiple notches in the frequency spectrum. In another aspect of the invention, an orthogonal frequency division multiplex transmitter comprises a modulator adapted to provide P frequency carriers, to turn off M frequency carriers of the P frequency carriers, to receive data, and to modulate the data onto a remaining N≦P−M frequency carriers to produce N mutually orthogonal modulated frequency carriers; means for combining the N mutually orthogonal modulated frequency signals into an orthogonal frequency division multiplex signal; a transmission window adapted to apply a window function to the orthogonal frequency division multiplex signal to produce a windowed orthogonal frequency division multiplex signal; and a transmitter transmitting the windowed orthogonal frequency division multiplex signal, wherein the M turned-off frequency carriers are consecutively arranged within the frequency band so as to create a notch in the frequency spectrum of the windowed orthogonal frequency division multiplex signal. Multiple groups of consecutively arranged frequency carriers may be left unmodulated and turned off to create multiple notches in the frequency spectrum.

In yet another aspect of the invention, a method of transmitting data comprises modulating data onto a plurality of frequency carriers to produce a plurality of mutually orthogonal modulated frequency signals; combining the mutually orthogonal modulated frequency signals into an orthogonal frequency division multiplex signal; multiplying the orthogonal frequency division multiplex signal by a transmission windowing function to produce a windowed orthogonal frequency division multiplex signal; and transmitting the windowed orthogonal frequency division multiplex signal, wherein the windowed orthogonal frequency division multiplex signal includes a first set of the frequency carriers uniformly spaced apart from each other in frequency by a spacing Δf, and a second set of the frequency carriers spaced apart from each other in frequency by the same spacing Δf, and there is a notch of at least 2Δf between the first set of frequency carriers and the second set of frequency carriers. Multiple notches of at least 2Δf may be created in the frequency spectrum.

FIG. 1A shows the frequency spectrum of an OFDM signal wherein a portion of the frequency band spanning X of the OFDM frequency carriers is to be evacuated and only the X carriers are turned off;

FIG. 1B shows the frequency spectrum of an OFDM signal wherein a portion of the frequency band spanning X of the OFDM frequency carriers is to be evacuated, and in addition to turning off the X carriers, an additional Z carriers on each side of the portion to be evacuated are also turned off;

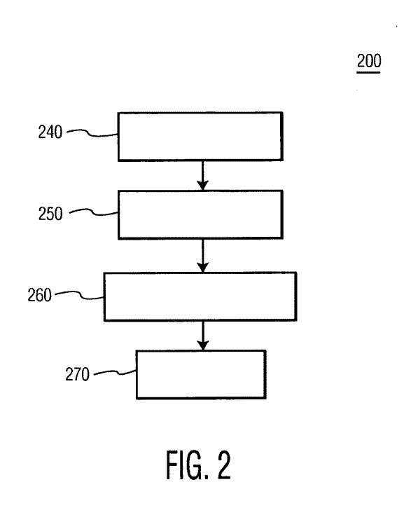

FIG. 2 is a high level functional block diagram of a windowed OFDM transmitter;

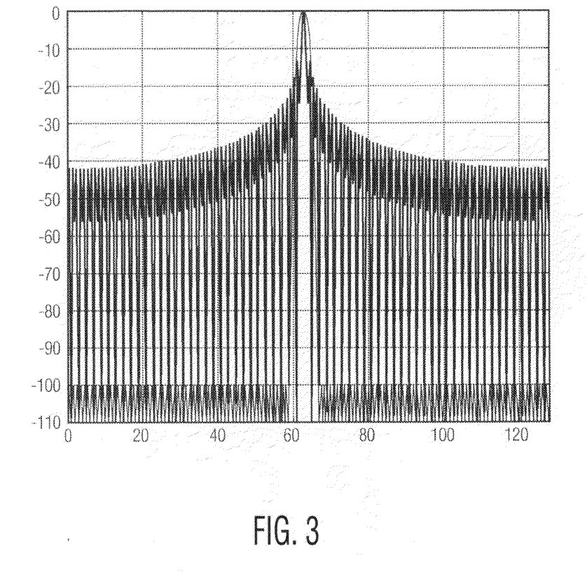

FIG. 3 shows the frequency spectrum of a single frequency carrier with a rectangular window (i.e., no window), and a single carrier after being windowed by a Chebyshev window with α=5;

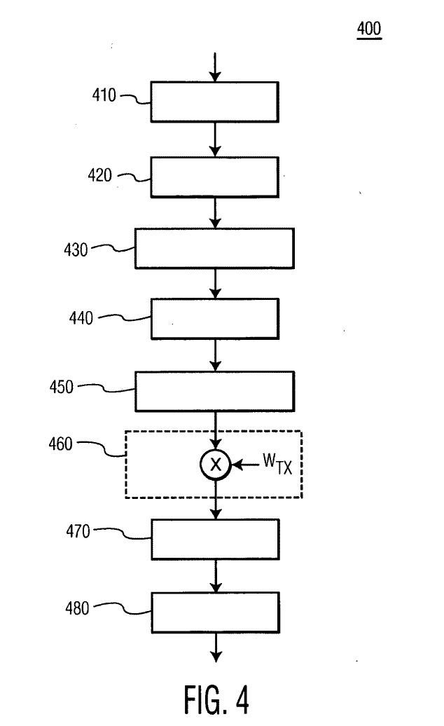

FIG. 4 is a functional block diagram of on embodiment of an OFDM transmitter having a digital implementation;

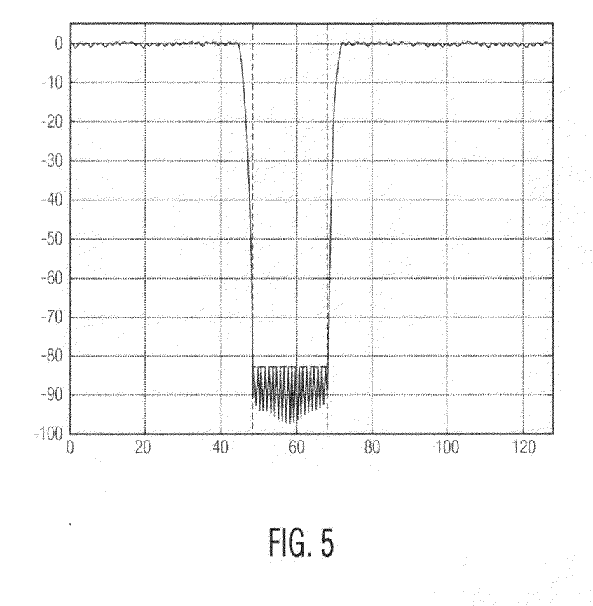

FIG. 5 shows the frequency spectrum of a windowed OFDM signal with M=13 frequency carriers turned-off

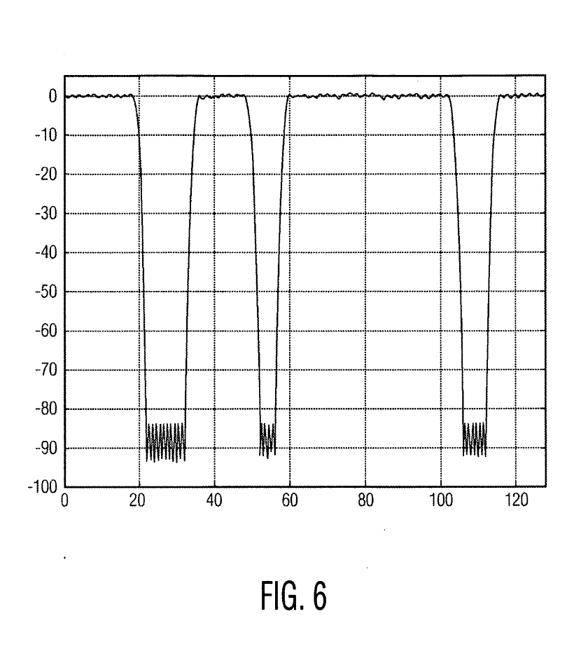

FIG. 6 shows the frequency spectrum of a windowed OFDM signal with multiple notches.

FIG. 2 shows a high level functional block diagram of a windowed orthogonal frequency division multiplex (OFDM) transmitter 200. Windowed OFDM transmitter 200 includes OFDM modulator 240, a signal combiner 250, a transmission window 260, and a transmitter 270. As will be appreciated by those skilled in the art, one or more of the various “parts” shown in FIG. 2 may be physically implemented using a software-controlled microprocessor, hard-wired circuits, or a combination thereof. Also, while the parts are functionally segregated in FIG. 2 for explanation purposes, they may be combined in any physical implementation.

OFDM modulator 240 generates a plurality (e.g., P) of frequency carriers uniformly spaced apart by a frequency spacing Of across a predetermined frequency band. OFDM modulator 240 is adapted to selectively turn off any combination of one or more of the P frequency carriers to create one or more frequency notches of at least 2Δf, as will be discussed in more detail below. OFDM modulator 240 is also adapted to modulate data onto any or all of the P frequency carriers to produce mutually orthogonal modulated frequency carriers. Although in theory, OFDM modulator 240 may include a plurality of individual, synchronized frequency sources, in practice such an analog approach is complicated and expensive, and takes up a lot of space. Accordingly, in practice typically a digital implementation is employed, as described in detail below with respect to FIG. 4.

Signal combiner 250 combines the mutually orthogonal modulated frequency carriers to produce an orthogonal frequency division multiplex (OFDM) signal.

Transmission window 260 applies a transmission window function WTX(n) to the OFDM signal to produce a windowed OFDM signal. The shape of the frequency spectrum of each modulated frequency carrier of the OFDM signal is changed by transmission window 260, depending on the shape of the window. The window function W TX(n) maybe any function (e.g., a Chebyshev windowing function) which produces a desired frequency spectrum profile for the mutually orthogonal modulated frequency carriers comprising the windowed OFDM signal. In one exemplary embodiment, the window function is a Chebyshev windowing function with α=5.

FIG. 3 shows the frequency spectrum of a single frequency carrier with a rectangular window (i.e., no window), and the frequency spectrum of a single carrier after being windowed by a Chebyshev window with α=5. As can be seen in FIG. 3, when the carrier is windowed by the Chebyshev windowing function, the bandwidth of the main lobe is increased. However, beneficially, the amplitude of the sidelobes of the windowed OFDM frequency carrier are dramatically reduced by over 10 dB compared to the OFDM frequency carrier with no windowing.

Transmitter 270 transmits the windowed OFDM signal, and may include amplification, filtering, and/or frequency upconversion blocks. Beneficially, windowed OFDM transmitter 200 is included in a terminal, such as a base station or a remote station, of a wireless communication network. Alternatively, it may be used in a de-centralized wireless network.

In operation, windowed OFDM transmitter 200 operates a follows. When an incumbent transmission is present in a portion of the frequency band of OFDM transmitter 200, then the incumbent transmission may be detected by windowed OFDM transmitter 200, or more typically is detected by some other section of a terminal that includes windowed OFDM transmitter 200. At that time, it is determined what portion of the frequency band is occupied by the incumbent transmission. For example, it may be determined that the incumbent transmission occupies a portion of the frequency band spanning X of the P frequency carriers of windowed OFDM transmitter 200. In that case, OFDM carrier modulator 240 turns off M of the L frequency carriers spanning the portion of the frequency band occupied by the incumbent transmission, where M≧X, to create a frequency'notch in its operating frequency band. At this time, OFDM modulator 240 modulates the data to be transmitted only onto a remaining N≦P−M frequency carriers that have not been turned off, to produce N mutually orthogonal modulated frequency carriers. That is, data is not modulated onto the frequency carriers that have been turned off.

Signal combiner 250 combines the N mutually orthogonal modulated frequency carriers to produce an OFDM signal. In the case where the orthogonal modulated frequency carriers are a plurality of individual, synchronized frequency sources, then the signal combiner 250 may be an RF combiner network. Meanwhile in the more typical case of a digital implementation, as discussed below with respect to FIG. 4, the signal combiner may be realized in an inverse fast Fourier transformer (IFFT) in combination with a parallel-to-serial converter.

Then, as explained above, transmission window 260 applies a transmission window function W_{TX}(n) to the OFDM signal to produce a windowed OFDM signal, and transmitter 270 transmits the windowed OFDM signal. Beneficially, when OFDM modulator 240 creates a frequency notch within its operating frequency band, the windowed orthogonal frequency division multiplex signal includes a first set of frequency carriers uniformly spaced apart from each other in frequency by a spacing Δf, and a second set of frequency carriers spaced apart from each other in frequency by the same spacing Δf, and there is a notch of at least 2Δf between the first set of frequency carriers and the second set of frequency carriers. Of course multiple notches could be created within the operating band by turning off two or more groups of consecutively arranged frequency carriers.

FIG. 4 shows an embodiment of a windowed OFDM transmitter 400 having a digital implementation. Windowed OFDM transmitter 400 includes symbol modulator 410, up-sampler 420, serial-to-parallel converter 430, an OFDM modulator comprising an inverse fast Fourier transformer (IFFT) 440, a parallel-to-serial converter 450, a transmission window 460, a block adding Cyclic Prefix (CP) or Zero Padding (ZP) 470, and a transmitter 480. Optionally, the CP/ZP block can be implemented before the transmission window. As will be appreciated by those skilled in the art, one or more of the various “parts” shown in FIG. 4 may be physically implemented using a software-controlled microprocessor, hard-wired circuits, or a combination thereof. Also, while the parts are functionally segregated in FIG. 4 for explanation purposes, they may be combined in any physical implementation.

Symbol modulator 410 maps data bits to transmission symbols. In a case where each data bit corresponds uniquely to one transmission symbol, then symbol modulator 410 may be omitted.

As seen above in FIG. 3, when a frequency carrier of an OFDM signal is windowed by some windowing functions (e.g., a Chebyshev windowing function), the bandwidth of the main lobe is increased. The wider main lobe means that each frequency carrier of the combined signal will interfere with its neighbors. To mitigate this interference, data is modulated only on every L-th frequency carrier, where L is an integer greater than 1. In that case, up-sampler 420 creates null symbols between each symbol received from the symbol modulator 410 in order to ensure that the data to be transmitted is only placed on every L-th frequency carrier of the OFDM signal. For example where L=2, every other carrier of the OFDM signal is modulated with data, and the remaining carriers are not modulated with data and are turned off.

Alternatively, the up-sampler 420 may be omitted by packing the frequency carriers more closely together and canceling the resulting intersymbol interference (ISI) at the receiver end using an ISI cancellation scheme.

Serial-to-parallel converter 430 converts the up-sampled symbols from a serial stream to a parallel set of streams, where the number of parallel streams corresponds to the number of frequency carriers to be modulated in the OFDM modulator. Of course in a case where symbol modulator 410 and up-sampler 420 are omitted, then the data could be provided externally to IFFT transformer 440 already in parallel fashion. In that case, windowed OFDM transmitter 400 may not need to include serial-to-parallel converter 430.

In the embodiment of FIG. 4, the OFDM modulator is an IFFT transformer 440 that provides P IFFT frequency bins which may be populated with data symbols. Each IFFT bin corresponds to one of a plurality of frequency carriers uniformly spaced apart across a predetermined frequency band. When it is determined that an incumbent transmission occupies a portion of the frequency band of OFDM transmitter 400 spanning X of the P frequency carriers, then OFDM carrier modulator 440 turns off M of the L frequency carriers spanning the portion of the frequency band occupied by the incumbent transmission, where M≧X, by not populating the corresponding M IFFT bins. IFFT transformer 440 populates a remaining N IFFT frequency bins (N≦P−M) with data from serial-to-parallel converter 430, and transforms the N populated frequency bins into N parallel OFDM transmission symbols.

Parallel-to-serial converter 450 converts the N parallel OFDM transmission symbols into a serial string of N OFDM transmission symbols.

Transmission window 460 multiplies the OFDM transmission symbols by a transmit window (W_{TX}) to generate a windowed OFDM signal. The additional computational complexity of the windowing function is exactly N multiplications for each OFDM symbol, which is not a severe computational burden.

Alternatively, it is possible that transmission window 460 may operate separately in parallel on the N parallel OFDM transmission symbols output from the IFFT transformer 440, and then parallel-to-serial converter 450 may convert the N windowed parallel OFDM transmission symbols into the windowed OFDM signal.

Before transmission, a Cyclic Prefix (CP) or Zero Padding (ZP) will be added by block 470. Optionally, the insertion of CP or ZP may take place before the OFDM transmission symbols are passed through transmission window 460.

Finally, transmitter 480 transmits the windowed OFDM signal.

FIG. 5 shows the frequency spectrum of a windowed OFDM signal with M=13 frequency carriers turned-off to vacate a portion of the frequency band spanning X=10 carriers of windowed OFDM transmitter 500. In the example shown in FIG. 5, the transmission window is a Chebyshev window with α=5. Also, up-sampling is employed with L=2. In this case, a notch having a width of 20 carriers and a depth of 83 dB is produced by turning off the M=13 data carriers. As can be seen by comparing the spectrum of FIG. 5 with the spectra of FIGS. 1A-B above, a much deeper frequency notch is created by the windowed OFDM transmitter 500.

Aside from creating deep notches that cannot be created using the other systems and methods producing the spectra of FIGS. 1A-B, the windowed OFDM system and method described above is capable of creating multiple deep notches of different widths “on-the-fly” (time variable) and with little additional complexity (see FIG. 6), simply by turning off groups of sub-carriers in different portions of the OFDM symbol. The disadvantage of this method is the reduced spectral efficiency (only in the cases with L>1). This problem can be overcome by using larger constellations on each frequency carrier (at the price of increased transmission power), or it may be accepted as the price of using unassigned spectrum.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

What is claimed is:

1. A method of transmitting data, comprising: providing P frequency carriers uniformly spaced apart across a frequency band; determining that an incumbent transmission is present in a portion of the frequency band spanning X of the P frequency carriers; turning off at least M of the frequency carriers spanning the portion of the frequency band where the incumbent transmission is present, where M≧X, and modulating data only onto a remaining N≦P−M frequency carriers to produce N mutually orthogonal modulated frequency carriers; performing an inverse fast Fourier transform on the N mutually orthogonal modulated frequency carriers to produce N OFDM transmission symbols; windowing the N OFDM transmission symbols with a window function WTX(n) and performing a parallel-to-serial conversion of the N OFDM transmission symbols to produce a windowed orthogonal frequency division multiplex signal; and transmitting a windowed orthogonal frequency division multiplex signal, wherein the M turned-off frequency carriers are consecutively arranged within the frequency band so as to create a notch in the frequency spectrum of the windowed orthogonal frequency division multiplex signal.

2. The method of claim 1, wherein the parallel-to-serial conversion of the N OFDM transmission symbols is performed before windowing the N OFDM transmission symbols.

3. The method of claim 1, wherein the windowing of the N OFDM transmission symbols is performed before the parallel-to-serial conversion of the N OFDM transmission symbols.

4. The method of claim 1, wherein modulating the data onto N frequency carriers comprises assigning each sample of the data into one of N IFFT bins, and wherein turning off the M frequency carriers comprises assigning data values of zero to each of M IFFT bins.

5. The method of claim 1, further comprising mapping the data to unmodulated symbols prior to modulating the data onto the N frequency carriers.

6. The method of claim 5, further comprising performing a serial-to-parallel conversion on the unmodulated symbols prior to modulating the data onto the N frequency carriers.

7. The method of claim 6, further comprising, prior to performing the serial-to-parallel conversion: modulating the data onto every Lth frequency carrier; not modulating any data onto the other frequency carriers; and turning off the other frequency carriers, where L is an integer greater than 1.

8. The method of claim 1, further comprising turning off a second group of R frequency carriers consecutively arranged within the frequency band to create a second notch in the frequency spectrum of the windowed orthogonal frequency division multiplex signal, where N≦P−M−R

9. An orthogonal frequency division multiplex transmitter, comprising: a modulator (240, 410) adapted to provide P frequency carriers, to turn off M frequency carriers of the P frequency carriers, to receive data, and to modulate the data only onto a remaining, N≦P−M frequency carriers to produce N mutually orthogonal modulated frequency carriers; means (250, 440/450) for combining the N mutually orthogonal modulated frequency signals into an orthogonal frequency division multiplex signal; a transmission window (260, 460) adapted to apply a window function to the orthogonal frequency division multiplex signal to produce a windowed orthogonal frequency division multiplex signal; and a transmitter (270, 480) transmitting the windowed orthogonal frequency division multiplex signal, wherein the M turned-off frequency carriers are consecutively arranged within the frequency band so as to create a notch in the frequency spectrum of the windowed orthogonal frequency division multiplex signal.

10. The transmitter (400) of claim 9, wherein the means for combining the mutually orthogonal modulated frequency signals into an orthogonal frequency division multiplex signal comprises an inverse Fast Fourier transformer (IFFT) (440).

11. The transmitter (400) of claim 10, wherein the means for combining the mutually orthogonal modulated frequency signals into an orthogonal frequency division multiplex signal further comprises a parallel-to-serial converter (450) adapted to convert OFDM transmission symbols produced by the IFFT into the orthogonal frequency division multiplex signal.

12. The transmitter (400) of claim 9, further comprising a symbol mapper (410) adapted to map the data to unmodulated symbols prior to modulating the data onto the N frequency carriers.

13. The transmitter (400) of claim 12, further comprising a serial-to-parallel converter (430) adapted to convert the unmodulated symbols from a serial format to a parallel format prior to modulating the data onto the N frequency carriers.

14. The transmitter (400) of claim 13, further comprising an up-sampler (420) which, prior to performing the serial-to-parallel conversion modulates the data onto every Lth frequency carrier, does not modulating any data onto the other frequency carriers, and turns off the other frequency carriers, where L is an integer greater than 1.

15. A method of transmitting data, comprising: modulating data onto a plurality of frequency carriers to produce a plurality of mutually orthogonal modulated frequency signals; combining the mutually orthogonal modulated frequency signals into an orthogonal frequency division multiplex signal; multiplying the orthogonal frequency division multiplex signal by a transmission windowing function to produce a windowed orthogonal frequency division multiplex signal; and transmitting the windowed orthogonal frequency division multiplex signal, wherein the windowed orthogonal frequency division multiplex signal includes a first set of the frequency carriers uniformly spaced apart from each other in frequency by a spacing Δf, and a second set of the frequency carriers spaced apart from each other in frequency by the same spacing Δf, and there is a notch of at least 2Δf between the first set of frequency carriers and the second set of frequency carriers.

16. The method of claim 15, wherein modulating the data onto the plurality of frequency carriers comprises: assigning each sample of the data into one of a plurality of IFFT bins, and performing an IFFT on the data samples.

17. The method of claim 15, further comprising mapping the data to unmodulated symbols prior to modulating the data onto the plurality of frequency carriers.

18. The method of claim 17, further comprising performing a serial-to-parallel conversion on the unmodulated symbols prior to modulating the data onto the plurality of frequency carriers.

19. The method of claim 18, further comprising, prior to performing the serial-to-parallel conversion: modulating the data onto every Lth frequency carrier; not modulating any data onto the other frequency carriers; and turning off the other frequency carriers, where L is an integer greater than 1.

20. The method of claim 18, wherein the window function is a Chebyshev function.
